(19) United States
(12) Patent Application Publication
(10) Pub. No.: US 2006/0191180 A1
(43) Pub. Date: Aug. 31, 2006

(54) Tailgate video display

(76) Inventors: Ron Williams, Seal Beach, CA (US); Ted Thacker, Signal Hill, CA (US)

Correspondence Address: FULWIDER PATTON LEE & UTECHT, LLP, 200 OCEANGATE, SUITE 1550, LONG BEACH, CA, 90802, US

(21) Appl. No.: 11/067,166

(22) Filed: Feb. 25, 2005

(51) Int. Cl. G09F 21/04

(52) U.S. Cl. 40/591

(57) ABSTRACT

A video display for a pick-up truck tailgate is disclosed, wherein a video screen is adapted for mounting in a truck bed for rearwardly facing projection of video images such as advertising, promotional video, entertainment, warning or cautionary information, and the like. The display is mounted using a pair of vertical brackets that support the video screen at the rear edge of the truck bed at the tailgate location. A power converter in the truck cabin produces AC power from the truck's DC battery that can be used to power the display. Using a plug and socket arrangement, the video screen may be releasably connected to a cross-beam type brace spanning the truck bed to fix the screen in the designated position, allowing for viewing from behind the vehicle.

### FIELD OF THE INVENTION

The invention relates generally to vehicle accessories used for promotion, and more particularly to a tailgate display system for a pick-up truck adapted for projecting video information from a moving vehicle.

### BACKGROUND OF THE INVENTION

Mobile advertising is a popular form of promotion, and exists in various forms. Bumper stickers and artwork on vehicles are but one type of mode for conveying a message to the viewing drivers and passengers of other vehicles. More recently, billboards carried on trailers that display advertising or other messages on each side and can be viewed by passing vehicles is a common form of mobile advertising. Audio messages played through vehicle's loudspeakers are yet another form of promotion that is well established in the art. However, while these messages and forms of expression can convey some useful information, they are limited in the amount of information that can be conveyed and have limited appeal to onlookers and occupants in neighboring vehicles. A viewer's attention will be diverted elsewhere once the message is read, assuming the static display even catches the viewer's attention to begin with. Also, these forms of expression have limited applicability at night and are typically limited to a single thoughts or expressions.

### SUMMARY OF THE INVENTION

The present invention overcomes the limitations of the prior art by using a video display system designed for a pick-up truck bed to displace the tailgate with a video screen. The rearwardly facing, horizontally configured video screen projects images and video to viewers from data either stored in a video player or transmitted via broadcast from a receiver within the truck cabin. Using controls for the video player or receiver, the driver or passenger of the pick-up truck can select from various stored messages or video display information that can include advertising, promotional materials, entertainment video, animation, product information, or visually stimulating effects. Moreover, using a power converter the video display system can be powered by converting the energy from the vehicle into standard electrical power. To mount the system to the pick-up bed, a support is constructed with guides for positioning the video display screen in the preferred orientation at the tail gate. The support system will preferably include a locking mechanism for releasably fixing the display screen in the desired position and stabilizing the screen for the vibration and oscillations that accompany ordinary driving conditions.

### BRIEF DESCRIPTION OF THE DRAWINGS

FIG. 1 is an elevated perspective view of the components of a preferred embodiment of the present invention;

FIG. 2 is an elevated, perspective view partially in shadow of a locking mechanism of the preferred embodiment of FIG. 1;

FIG. 3 is a housing for the video display unit of the preferred embodiment of FIG. 1;

FIG. 4 is a rear view of the housing of FIG. 3;

FIG. 5A is a side view of the mounting bracket and video display unit housing prior to engagement; and

FIG. 5B is a side view of the mounting bracket and video display unit housing after engagement.

### DETAILED DESCRIPTION OF THE INVENTION

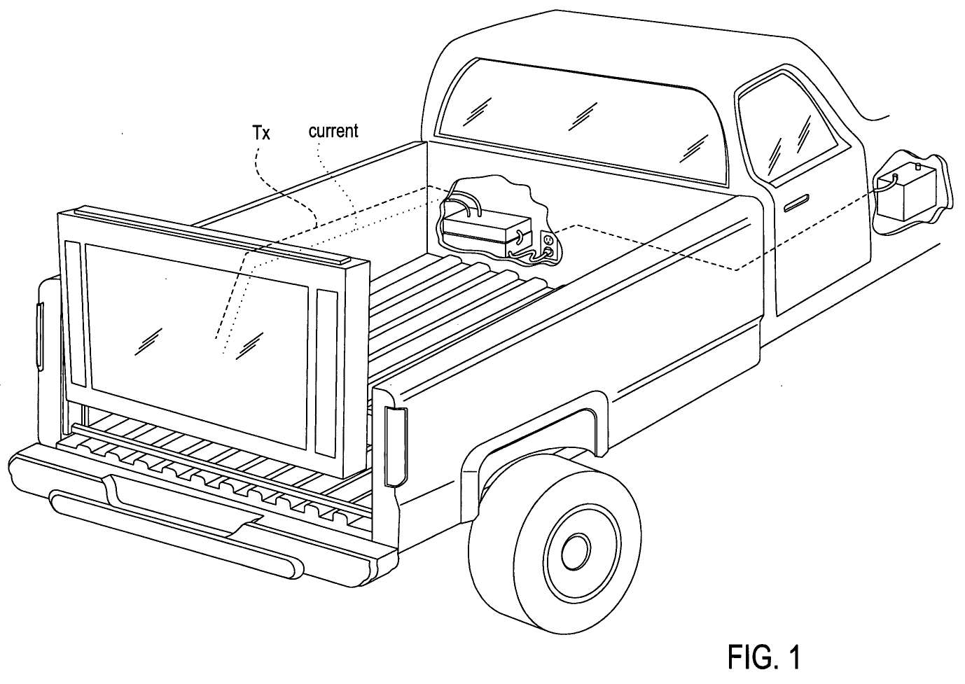

A system meeting the objects of the present invention is shown generally in FIG. 1, which illustrates a pick-up truck 10 with an open truck bed 12. Shown within the cabin area is a video storage unit 14 and a power converter 16. The power converter 16 is connected via a minimum four gauge stranded copper cable 20 directly to the vehicle's power supply, traditionally a twelve volt battery 18. The power converter 16 converts the DC twelve volts to 120 volt AC power using the alternator (now shown) having at least 120 volt capability. A 110 watt G.F.I. electrical outlet 28 is mounted in the truck cabin and the power converter 16 is plugged into the outlet 28. As long as the vehicle is operating and the alternator is functioning, the power converter will supply a reliable 120 volt ac power to the video display unit 26 for powering the unit. The video storage unit 14 is connected via a cables 22, 24 to video display unit 26, where the cable 22 conveys electrical power and cable 24 is a high quality data cable to relay the video signals. The video display unit 26 is preferably a liquid crystal display (LCD) video screen or a light emitting diode (LED) video screen. Plasma monitors are not well suited for the present application because the vibration and g-forces resulting from the moving vehicle disrupts the gaseous distribution within the cells of the plasma monitor and would likely damage the plasma screen using current technology. Projection screen monitors are also ill-suited for the present application because the vehicle's motion would likely impair the translucent globe component at the heart of the monitor that is necessary for the image projection process to occur.

The video storage unit 14 may preferably be a soft float dvd player mounted in the truck cab adjacent the power converter and powered by the power converter 16. Alternately, a video storage unit can include a hard drive stored with video content or comprise a receiver for receiving broadcast video signals. From its position in the truck cabin, the video storage unit can be manipulated as needed to restart a video programming, change programs, adjust the picture quality, and generally control the video display process.

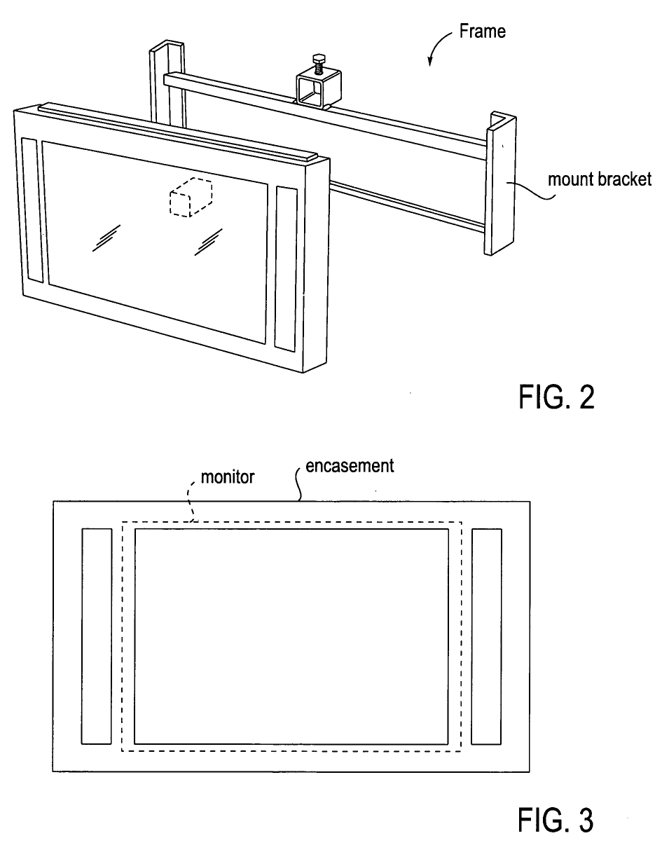

FIG. 2 illustrates a mounting system for the video display unit 26 that allows the video display unit to mount directly to the tailgate support of the pick-up truck. The system includes a mounting frame 30 comprising first and second vertical brackets 32 that can be bolted directly to the inwardly facing edges of the truck bed tailgate supports 34. Connecting the brackets 32 is a traverse cross-beam 36 sized to span the specific width of the truck bed used, where the cross-beam 36 and vertical brackets cooperate for form a rigid frame to support the video display unit 26. Mounted on the transverse cross-beam 36 is a socket 38 positioned to coincide with and receive therein a plug 40 on the forward-facing surface 42 (with respect to the truck) of the housing 44 of the video display unit 26. The socket 38 includes a locking mechanism such as a bolt 50 to releasably secure the plug 40 in the socket 38, ensuring the reliable coupling of the video display unit 26 to the truck bed. The housing 44 is shown in greater detail in FIG. 3, wherein a rectangular housing includes a pair of windows 46 for speakers and a large window for the monitor 48 of the video display unit 26. Either the housing or the monitor will include a protective casing for the monitor 48 to prevent damage from rocks, debris, minor collisions, vandalism, and the like. The protective casing preferably provides for ventilation of the monitor to promote cooling and resist overheating. The protective casing will also shield the monitor from moisture and condensation that can impair or damage the monitor 48.

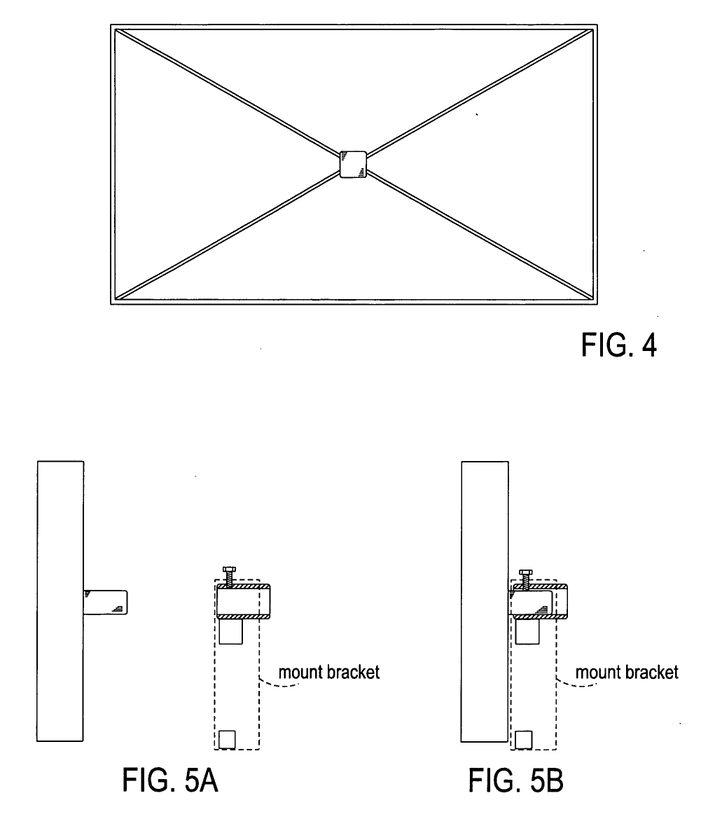

On the forward facing surface 42 (FIG. 4) is an outwardly projecting plug 40 shaped to fit inside the socket 38 of the mounting frame 30. The plug 40 includes an aperture 52 that coincides with the bolt 50 to lock the plug 40 in the socket 38. As shown in FIGS. 5A, 5B, when the video display unit 26 in its designated housing 44 is placed adjacent the mounting frame 30, the plug 40 is aligned with the socket 38. With the locking bolt 50 clear of the path of the plug 40, the video display unit 26 is slid into position such that the plug 40 occupies the socket 38. The bolt 50 is then passed through the socket 38 and the plug 40 coupling the housing to the mounting frame 30. The housing is preferably made of a steel or high strength aluminum alloy to support the video display unit and make sure the display unit is maintained in the vertical orientation.

In a preferred embodiment, the system is equipped with a global position system (GPS) tracking device to monitor the position of the vehicle for tracking purposes. Such a system can be used to track the areas traveled by the vehicle to ensure that the driver is reaching the designated viewing locations. A web based and internet accessed customer service web site would allow a customer to view using the GPS tracking device and an onscreen map the exact location of the vehicle and any given instant. Such tracking allows the customer to feel confident the services being paid for are actually achieved without physically following the vehicle.

It should be understood that the present invention is not limited to the described embodiments, but rather those of ordinary skill in the art would appreciate alternative embodiments to those described above would be included within the scope of the present invention. Accordingly, the disclosure should be viewed as exemplary and not limited, and the scope of the invention is properly defined by the words of the claims appended hereto.

We claim:

1. A video display system for a pick-up truck that includes a truck cabin and a truck bed having a bed floor and first and second bed side walls, comprising:
a horizontal display screen mounted on said bed floor between said first and second bed walls for projecting video information rearwardly;
a mounting frame including first and second brackets disposed in said truck bed for orienting said display screen in a horizontal position;
a locking mechanism for securing said display screen to said mounting frame;
a power converter for driving said display screen using a vehicle electrical power supply; and
a video control unit connected to the display screen for controlling the video output of said display screen.

2. The video display system of claim 1 wherein said locking mechanism includes a cross beam connecting said brackets, and further comprising a socket on said cross beam positioned to receive a post associated with said display screen, said socket and post further comprising mating holes for receiving a traverse pin for locking said display screen to the cross beam.

3. The video display system of claim 1 wherein said brackets are mounted to respective first and second bed side walls.

4. The video display system of claim 1 wherein said display screen replaces a tailgate of said pick-up truck.

5. The video display system of claim 1 wherein the power converter converts DC power from a vehicle's battery to AC power for use in driving said display screen.

6. The video display system of claim 1 wherein said display screen has a flat display surface.

7. The video display system of claim 1 further comprising a GPS tracking device for monitoring the position of the vehicle at all times.

8. The video display system of claim 7 further comprising a web based internet site accessible to retrieve real time positional data of the vehicle display system.

9. The video display system of claim 1 wherein said display screen is an LED display screen.

10. The video display system of claim 1 wherein the display screen is an LCD display screen.
